(19) United States
(12) Patent Application Publication
(10) Pub. No.: US 2002/0093325 A1
(43) Pub. Date: Jul. 18, 2002

(54) Low voltage bandgap reference circuit

(76) Inventor: Peicheng Ju, Berkeley Heights, NJ (US)

Correspondence Address: Schnader Harrison Segal & Lewis, LLP, 1600 Market Street, 36th Floor, Philadelphia, PA, 19103, US

(21) Appl. No.: 10/007,913

(22) Filed: Nov. 8, 2001

Related U.S. Application Data
(60) Provisional application No. 60/247,367, filed on Nov. 9, 2000.

(51) Int. Cl. G05F 3/16; G05F 3/20

(52) U.S. Cl. 323/316; 323/313; 323/314; 323/315

(57) ABSTRACT

A bandgap reference circuit that may use reduced substrate area compared to prior art bandgap reference circuits, while requiring relatively low voltage. The circuit may include a bipolar transistor with a resistor electrically connected across the emitter-base of the bipolar transistor. The resistor sums a first current with a second current and also generates a fractional V_{EB}. The bandgap reference circuit may have a first current proportional to V_{EB}, and a second current proportional to a PTAT current. An impedance booster may be incorporated into the circuit. Also disclosed is a method of regulating a voltage level using embodiments of the bandgap reference circuit.

### APPLICATION BASED ON A PROVISIONAL

This application is based on provisional application having serial No. 60/247,367, having a filing date of Nov. 9, 2000, and entitled Bandgap Reference Circuit for V_{DD}=0.75V in a 0.16 μm Digital CMOS.

### BACKGROUND OF THE INVENTION

As CMOS technologies continue to migrate into deep submicron region, the power supply voltage will likewise scale to below 1.5 V for reliable operation of devices. In various hand-held and/or wireless devices it is advantageous for the supply voltage to be reduced even further to keep power consumption and weight low. As an essential and integral part of more and more very large scale integration circuit systems, a temperature-compensated (or commonly called bandgap) reference circuit that works with supply voltages below 1.5 V is desired.

FIG. 1 shows a simplified diagram of a conventional CMOS bandgap reference circuit. The closed loop of on operational amplifier AO forces the voltages at nodes PT and Q2E to be equal, resulting in a bandgap reference voltage

$${V}_{REF} = \frac{{R}_{o}}{{R}_{PT}} ln ( {a}_{E} {m}_{2} ) {V}_{T} + {V}_{EB2} ,$$

where α_{E} is the ratio of emitter areas of Q₁ over Q₂, and M₂ is the current ratio, I₂/I₁. V_{T}=κT/q, the thermal voltage, has a positive temperature coefficient and V_{EB} has a negative temperature coefficient of about −2MV/° C. Satisfying the condition dV_{REF}/dT=0 for T=T₀ usually results in V_{REF}≈1.2 V with α_{E}=8, M₂=1. Allowing some voltage drop across the current sources M₁ and M₂, the minimum supply voltage will typically be V_{DD}≧1.5 V.

The minimum supply voltage required to properly operate this circuit is V_{DD}≧V_{REF}+V_{SD} since V_{REF}>V_{EB2}. A common technique to lower the minimum V_{DD} is to generate a Proportional To Absolute Temperature (“PTAT”) current and a current proportional to V_{EB}, and then sum the two currents into a resistor to generate a bandgap voltage that may contain only a fraction of a V_{EB} instead of a whole V_{EB} voltage. This is commonly referred as a fractional V_{EB} bandgap reference.

Bandgap a reference circuits with minimum supply voltages of V_{DD}≧0.9V have been achieved. A first technique results in a bandgap reference voltage V_{REF}>V_{EB}, which limits the supply voltage to V_{DD}≧0.9V. A second technique predicted a lowering of supply voltage to V_{DD}≧0.85V, but achieves only V_{DD}≧2.1V due to technology limitations. The second technique requires that two resistors be connected across the emitter-base terminals of two separate PNP transistors to generate a whole V_{EB} current and sum it with a PTAT current. It then forces the resultant current through a third resistor to produce an appropriate bandgap reference voltage. For a given voltage drop, Vₒ, across a resistor having a current, Iₒ, flowing through, the resistance of the resistor is Rₒ=V_{EB}/Iₒ. Therefore, the total resistence of the two resistors connected across the emitter-base terminals of two separate PNP transistors is

$${R}_{t} = 2 \frac{{V}_{EB}}{{I}_{o}} ,$$

where Iₒ is the current flowing through each resistor. For example, Iₒ=1 μA(10⁻⁶A) and V_{EB}=0.7V results in Rₜ32 1,400,000 Ω. In integrated circuit technologies, chip area needed to implement a resistor is directly proportional to the total resistance of the resistor. Therefore, additional resistors or resistances requires additional chip area.

### SUMMARY OF THE INVENTION

Embodiments of the invention provide a bandgap reference circuit that may use reduced substrate area compared to prior art bandgap reference circuits, while requiring relatively low voltage. A first embodiment of the invention includes a bipolar transistor with a resistor electrically connected across the emitter-base of the bipolar transistor. The resistor sums a first current with a second current and also generates a fractional V_{EB}.

In an illustrative embodiment of the invention the bandgap reference circuit has a first current is proportional to V_{EB}, and a second current proportional to a PTAT current.

In a further embodiment of the invention the bandgap reference circuit has an impedance booster.

The present invention also includes a method of regulating a voltage level using embodiments of the bandgap reference circuit.

### DESCRIPTION OF THE FIGURES

The invention is best understood from the following detailed description when read with the accompanying drawings.

FIG. 1 shows a diagram of a prior art CMOS bandgap reference circuit.

FIG. 2 depicts a CMOS bandgap reference circuits according to an illustrative embodiment of the invention.

FIGS. 3a-c depict illustrative circuit diagrams of a simple current source, a cascoded current source, and a cascoded current source with impedance boosting, respectively, that may be used in embodiments of the invention.

FIG. 4 depicts a circuit with impedance boosting according to an illustrative embodiment of the invention.

FIG. 5 depicts an illustrative operational amplifier that may be used in an embodiment of the invention.

### DETAILED DESCRIPTION OF THE INVENTION

Embodiments of the invention provide a bandgap reference circuit with a supply voltage lower than that of the prior art, and capable of being fabricated using less area than prior art circuits. The area savings is achieved by having a single resistor consisting of at least two segments connected in series across the emitter-base terminals of a PNP transistor to generate a fractional V_{EB} current and also to sum it with a PTAT current to generate a bandgap reference voltage. This is in contrast to prior art circuits that requires two separate PNP transistors to accomplish both of these tasks.

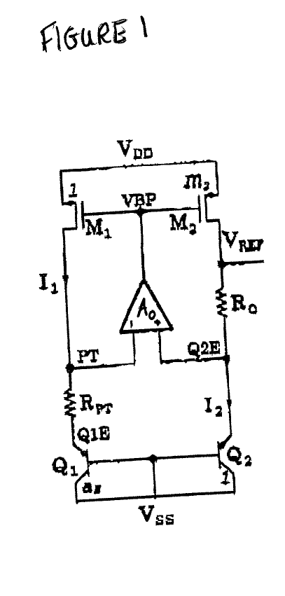

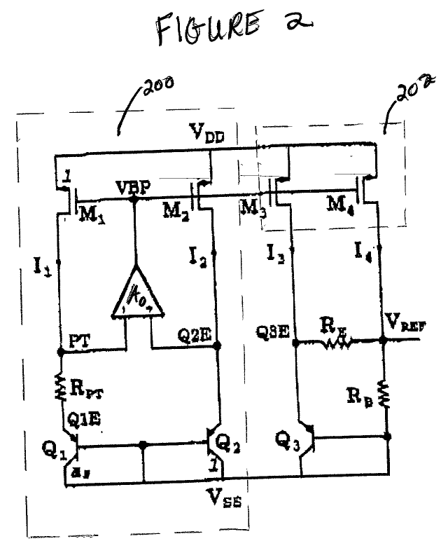

FIG. 2 depicts a CMOS bandgap reference circuit using a fractional V_{BE} for low V_{DD} applications according to an illustrative embodiment of the invention. The left hand portion of FIG. 2 represents a bandgap reference circuit 200 which functions in an analogous manner to that which is depicted in FIG. 1. FIG. 2 further depicts circuitry providing a fractional V_{BE} bandgap reference. The circuit may be configured to use less chip area because only one resistor, preferably consisting of two segments, R_{B} and R_{E}, in series is required to be connected across the emitter-base terminals of a PNP transistor, Q₃, and this resistor both generates a fractional V_{EB}. current and sums it with a PTAT current to produce a bandgap reference voltage. The total resistance of this resistor is R_{B}+R_{E}. If current Iₒ=1 μA (10⁻⁶A) is required to flow through it, and V_{EB}=0.7V, then the total resistance is Rₜ=700,00 Ω, which is half of the resistance required in prior art circuits without considering the third resistor also needed in the prior circuits. The fractional V_{EB} bandgap reference additionally includes PMOS device M₃, the gate of which is connected to the gate of PMOS device M₄ and to the gates of PMOS devices M₁ and M₂. M₃ and M₄ are commonly referred to as current mirrors of M₁ or M₂. M₄ supplies the PTAT current to the node V_{REF} to be summed with a fractional V_{EB} current by the resistor segment R_{B}, and therefore, the mirroring action must be accurate to guarantee low-sensitivity to temperature variation. M₃ only needs to supply sufficient current to node Q3E. The base terminal of the PNP transistor Q₃ is connected to V_{SS} as are also the base terminals of Q₁ and Q₂. The source terminals of PMOS devices M₁, M₂, M₃, and M₄ are all connected to the voltage supply node, V_{DD}.

The single resistor consisting of two segments R_{E} and R_{B} in series is connected between the emitter and base terminals of PNP transistor Q₃. By injecting a PTAT current, I₄, directly into the node V_{REF}, the resistors R_{B} and R_{E} perform both tasks of the generation of a fractional V_{EB} current and the summation of two currents, with opposite temperature coefficients. The voltage across R_{B} is

$${V}_{REF} = \frac{{M}_{3}}{{χ}_{BE + 1}} \frac{{R}_{B}}{{R}_{PT}} ln ( {a}_{E} {m}_{2} ) {V}_{T} + \frac{{χ}_{BE}}{{χ}_{BE + 1}} {V}_{BE3} ,$$

where χ_{BE}=R_{B}/R_{E} is the resistor ratio. The efficient use of resistors R_{B} and R_{E} means only one resistor of a total resistance (R_{B}+R_{E}) is connected across a single V_{EB} voltage, as compared to two such configurations in prior art circuits. Considering that the resistance elements usually take up ¼ to ⅓ of the area of a bandgap reference circuit in digital CMOS technologies.

The minimum supply voltage for proper operation of the circuit is V_{DD}≧V_{EB}+V_{SD} if the V_{REF}<V_{EB} is chosen for the lower portion of the interested temperature range where V_{EB} is large enough by choosing proper values of χ_{BE}. In order to lower V_{DD} further, one needs to reduce either V_{EB} or V_{SD}, or both. Since lowering V_{EB} requires increasing the emitter area and/or lowering I_{PTAT} by increasing R_{PT}, the silicon area required increases dramatically because V_{EB}∝lnI₀/A. Reducing V_{SD} of PMOS transistors that implement the current mirrors runs the risk of increased mismatch among the PTAT currents I₁, I₂, and I₄ because of the decreased output resistance of the current sources. For this reason, the minimum supply voltage for the circuit has been limited at V_{DD}≧0.85V for V_{EB}≦0.7V.

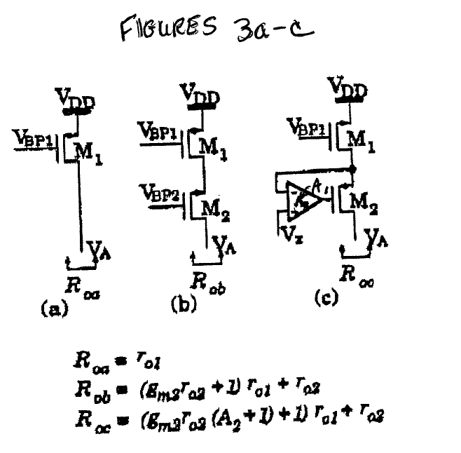

To overcome the mismatch problem in the current sources, an impedance boosting technique may be used. FIGS. 3a-c show illustrative circuit diagrams of a simple current source, a cascoded current source, and a cascoded current source with impedance boosting, respectively. The expressions for their output impedances are provided in FIGS. 3a-c as Rₒₐ, R_{ob} and R_{oc} respectively. V_{BP1} and V_{BP2} are bias voltages. In the embodiment depicted in FIG. 3c, a gain stage increases the output impedance of the circuit by the gain of the operational amplifier A₁, compared to the current source in FIG. 3b. For a given output voltage V_{A}, There may be situations of Rₒₗₐ>R_{olb}, R_{o2b}, R_{01c}, R_{o2c}, or even Rₒₐ>R_{ob}. With the additional gain stage A₁ inserted as in FIG. 3(c), however, R_{oc}>>R_{ob}, Rₒₐ can be achieved by the gain, A₁. This enables the reduction of the total voltage drop across the cascoded current source, and therefore, further lowering of the supply voltage, V_{DD}, while still maintaining good matching of the PTAT currents I₁, I₂, and I₄. With V_{EB2}≦0.7V, a bandgap reference circuit with a minimum V_{DD}≧0.75V can be designed.

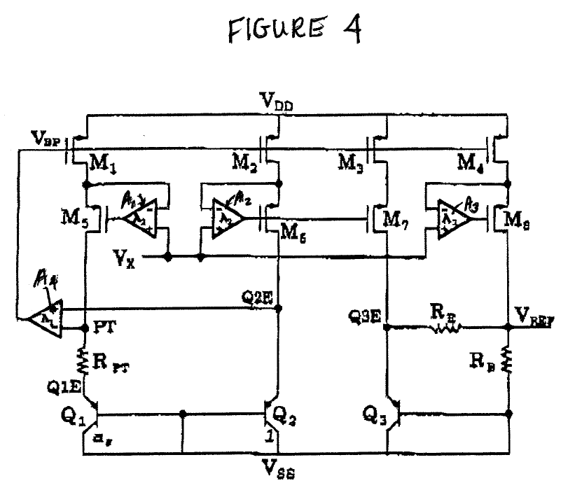

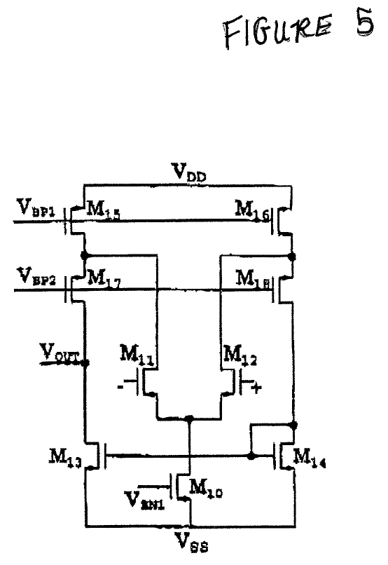

An illustrative circuit diagram with impedance boosting is shown in FIG. 4 (the start-up circuit is not shown). An illustrative operational amplifier is shown in FIG. 5. There are slight differences between operational amplifiers A₁ and A₂ due to different gain and offset requirements, but the basic topology may be the same. The folded-cascode operational amplifier topology allows low voltage implementation. In an exemplary embodiment of invention, the bandgap reference circuit and/or the independence booster is implemented in 0.16 μm digital CMOS technology.

The illustrative circuit of FIG. 4 may be described as follows. Voltage supply V_{DD} is connected to sources of CMOS devices M₁, M₂, M₃ and M₄. Drains of CMOS devices M₁ and M₂ are connected to the negative terminals of operational amplifiers A₁ and A₂, respectively. Outputs of operational amplifiers A₁ and A₂ are connected to the gates of CMOS devices M₅ and M₆, respectively. Voltage V_{BP} is connected to the gate of CMOS device M₁ and the output of operational amplifier A₄. Voltage V_{X} is provided to the positive terminals of operational amplifiers A₁, A₂ and A₃. Drains of CMOS devices M₅ and M₆ are connected to nodes PT and Q_{2E}, respectively. Resistor R_{PT} is connected to the emitter of transistor Q₁ and node PT. Voltage V_{SS} is connected to the base of transistors Q₁, Q₂ and Q₃. The non-inverting terminal of operational amplifier A₄ is connected to node Q2E, as are also the drain of device M₆ and emitter of transistor Q₂. A drain of CMOS device M₃ is connected to the source of CMOS device M₇. The drain of CMOS device M₇ is connected to node Q3E, as are also resistor R_{E} and the emitter of transistor Q₃. A node at V_{REF} is connected to resistors R_{E} and R_{B}, and the drain of CMOS device M₈. The gate of CMOS device M₈ is connected to the output of operational amplified A₃. The negative terminal of operational amplifier A₃ is connected to the source of CMOS device M₈ and the drain of CMOS device M₄. Resistor R_{B} is further connected to the base of transistor M₃.

The operational amplifier circuit diagram of FIG. 5 may be described as follows. Voltage supply V_{DD} is connected to the sources of CMOS devices M₁₅ and M₁₆. Gates of CMOS devices M₁₅ and M₁₆ are connected to one another and further to voltage V_{BP1}. Drains of CMOS devices M₁₅ and M₁₆ are connected to the drains of CMOS devices M₁₁ and M₁₂. CMOS devices M₁₁ and M₁₂ have sources connected to one another and further to the source of CMOS device M₁₀. Voltage V_{SS} is connected to the sources of CMOS devices M₁₀, M₁₃ and M₁₄. The gate of CMOS device M₁₀ is connected to V_{2N1}. V_{BP2} is connected to the gates of CMOS devices M₁₇ and M₁₈. Voltage V_{OUT} is connected to CMOS devices M₁₇ and M₁₃.

FIG. 4 shows plots of the measured bandgap voltage vs. temperature for V_{DD}=0.75 and 1.0V. It shows a stable reference voltage at about 0.57 V over a temperature range −45° to 125° C. The resistor ratio, X_{BE}=1 and current ratios m₂=m₄=1 are chosen. The variation of the reference voltage over the temperature range is 17 m Volts. The power supply rejection is about 20 dB at 100 kHz for V_{DD}=0.75V. Measurements of devices from several wafers have shown quite consistent results.

In an illustrative embodiment of the invention, the bandgap reference circuit has a supply voltage of less than about 0.80V. More preferably the supply voltage is less than about 0.75V, and most preferably less than about 0.70V.

Further embodiments include a method of regulating a voltage level using the techniques and circuits described above.

While the invention has been described by illustrative embodiments, additional advantages and modifications will occur to those skilled in the art. Therefore, the invention in its broader aspects is not limited to specific details shown and described herein. Modifications, for example, to circuit configurations and components, may be made without departing from the spirit and scope of the invention. Accordingly, it is intended that the invention not be limited to the specific illustrative embodiments but be interpreted within the full spirit and scope of the appended claims and their equivalents.

Claimed is:

1. A bandgap reference circuit comprising:
a bipolar transistor;
a resistor electrically connected across an emitter-base of the bipolar transistor;
wherein the resistor sums a first current with a second current and generates a fractional V_{EB}.

2. The bandgap reference of claim 1 wherein the first and second currents have opposite temperature coefficients.

3. The bandgap reference circuit of claim 1 wherein the first current is proportional to V_{EB}, and the second current is proportional to a PTAT current.

4. The bandgap reference circuit of claim 1 further comprising an impedance booster.

5. The bandgap reference circuit of claim 4 wherein the impedance booster includes a gain stage.

6. The bandgap reference circuit of claim 1 comprising digital CMOS technology.

7. The bandgap reference circuit of claim 1 wherein the bandgap reference circuit comprises about 0.16 μm digital CMOS technology.

8. The bandgap reference circuit of claim 1 wherein the bandgap reference circuit operates with a supply voltage of less than about 0.80V.

9. The bandgap reference circuit of claim 1 wherein the bandgap reference circuit operates with a supply voltage of less than about 0.75V.

10. The bandgap reference circuit of claim 1 wherein the bandgap reference circuit operates with a supply voltage of less than about 0.70V.

11. A method of regulating a voltage level comprising:
providing a bipolar transistor;
electrically connecting a resistor across an emitter-base of the bipolar transistor;
summing a first current with a second currents by the resistor; and
generating a fractional V_{EB} by the resistor.

12. The method claim 11 wherein the first and second currents have opposite temperature coefficients.

13. The method of claim 11 wherein the first current is proportional to V_{EB}, and the second current is proportional to a PTAT current.

14. The method of claim 11 further comprising:
boosting the impedance.

15. The method of claim 14 wherein the impedance is boosted with the use of a gain stage.

16. The method of claim 11 wherein the bandgap reference circuit comprises about 0.16 μm digital CMOS technology.

17. The method of claim 11 wherein the bandgap reference circuit operates with a supply voltage of less than about 0.80V.

18. The method of claim 11 wherein the bandgap reference circuit operates with a supply voltage of less than about 0.75V.

19. The method of claim 11 wherein the bandgap reference circuit operates with a supply voltage of less than about 0.70V.

20. A semiconductor device comprising a bandgap reference circuit according to claim 1.
